(19) United States
(12) Patent Application Publication
(10) Pub. No.: US 2007/0154374 A1
(43) Pub. Date: Jul. 5, 2007

(54) Method for removing sulfur dioxide and other acid gases, mercury, and nitrogen oxides from a gas stream with the optional production of ammonia based fertilizers

(75) Inventors: Dennis W. Johnson, Simpsonville, SC (US); Mark S. Ehrnschwender, Terrace Park, OH (US)

Correspondence Address: WOOD, HERRON & EVANS, LLP, 2700 CAREW TOWER, 441 VINE STREET, CINCINNATI, OH, 45202, US

(73) Assignee: EnviroSolv Energy LLC, Terrace Park, OH (US)

(21) Appl. No.: 11/326,259

(22) Filed: Jan. 5, 2006

(51) Int. Cl. B01D 53/46

(52) U.S. Cl. 423/210

(57) ABSTRACT

Methods for scrubbing gas streams to remove acid gases including sulfur dioxide, mercury-containing substances, and/or nitrogen oxides from the gas stream. The gas stream is contacted with an ammonium-based sorbent effective for removing at least a portion of the acid gases. The partially cleaned gas stream is then contacted with an oxidant effective to remove at least a portion of the nitrogen oxides and/or mercury-containing substances after partially removing the acid gas substance while producing ammonia based fertilizers.

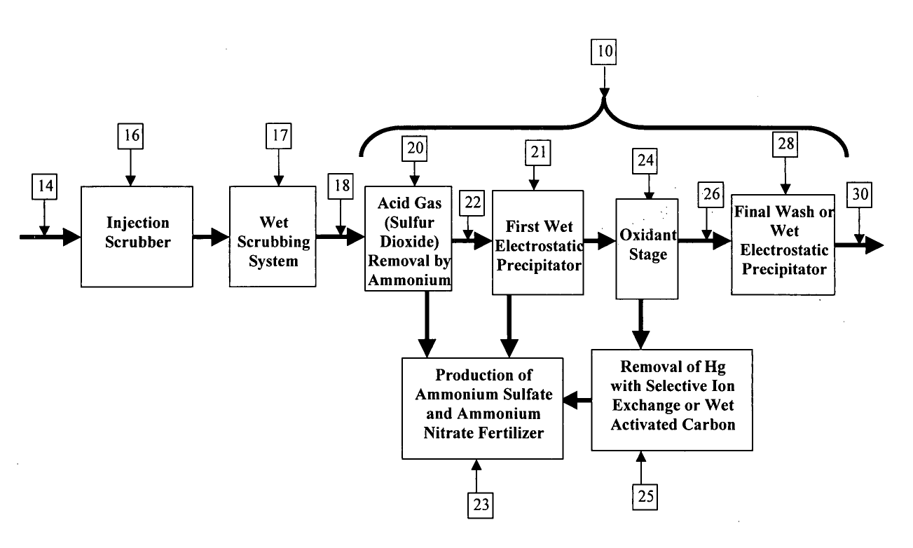

### FIELD OF THE INVENTION

The present invention relates to methods for removing pollutants, such as sulfur dioxide and other acid gases, nitrogen oxides, mercury compounds, and mercury (Hg), from gas streams.

### BACKGROUND OF THE INVENTION

In the pollution control field, several diverse approaches have been used to remove sulfur oxides (SOₓ) and other contaminants from gas produced by the burning of a fossil fuel in order to comply with Federal and State emissions requirements. One conventional approach involves locating and utilizing fossil fuels lower in sulfur content and/or other contaminants. Another conventional approach involves removing or reducing the sulfur content and/or other contaminants in the fuel, before combustion, via mechanical and/or chemical processes. A major disadvantage to this approach is the limited cost effectiveness of the mechanical and/or chemical processing required to achieve the mandated reduction levels of sulfur oxides and/or other contaminants.

The most prevalent conventional approaches for removing sulfur oxides and/or other contaminants from gas streams involve post-combustion clean up of the gases. Several conventional methods have been developed to remove the sulfur dioxide (SO₂) species from gases.

One conventional approach for removing SO₂ from gas streams involves either mixing dry alkali material with the fuel prior to combustion, or injection of pulverized alkali material directly into the hot combustion gases to remove sulfur oxides and other contaminants via absorption or absorption followed by oxidation. Major disadvantages of this approach include fouling of heat transfer surfaces (which then requires more frequent soot blowing of these heat transfer surfaces), low to moderate removal efficiencies, poor reagent utilization, and increased particulate loading in the combustion gases which may require additional conditioning of the gas, such as humidification or sulfur trioxide injection, if an electrostatic precipitator is used for downstream particulate collection.

Another conventional approach for removing SO₂ from gas streams, collectively referred to as wet chemical absorption processes and also known as wet scrubbing, involves “washing” the hot gases with an aqueous alkaline solution including ammonia based solutions or slurry in a gas-liquid contact device to remove sulfur oxides and other contaminants. These wet scrubbers operate at low temperatures (˜110-150° F.), generally at or close to the adiabatic saturation of the gas stream. Major disadvantages associated with these wet scrubbing processes include the loss of liquid both to the atmosphere due to, for example, saturation of the gas and mist carry-over, and to the sludge produced in the process, and the economics associated with the construction materials for the absorber module itself and all related auxiliary downstream equipment (i.e., primary/secondary dewatering and waste water treatment subsystems).

Ammonia based wet scrubbing is well known. Some of this prior art can be found in U.S. Pat. No. 6,277,343 to Gansley, et al., U.S. Pat. No. 6,187,278 to Brown, et al., U.S. Pat. No. 6,605,263 to Alix, et al., U.S. Pat. No. 5,362,458 to Saleem, et al. and U.S. Pat. No. 4,690,807 to Saleem. These prior art patents teach ammonia wet scrubbing and production of ammonium sulfate from the spent scrubbing solution, but do not employ downstream technologies to remove NOₓ or Hg. They also do not teach removal of acid gas and other pollutants in an optional staged approach. U.S. Pat. No. 4,690,807 to Saleem teaches the use of a single vessel for sulfur dioxide removal.

U.S. Pat. No. 6,936,231 Duncan, et al., and U.S. Pat. No. 6,132,692 to Alix, et al., teach an ammonium based scrubbing system preceded by a dielectric barrier discharge reactor for oxidizing at least a portion of NO in a gas stream to NO₂ and/or and at least a portion of the Hg in a gas stream to HgO. This type of electrical oxidizing requires a lot of energy, takes up more space, and has a high initial cost. U.S. Pat. No. 6,132,692 to Alix, et al., also teaches using a wet electrostatic precipitator.

U.S. Pat. No. 6,958,133 to Hammer, et al., teaches an apparatus and process for removing acidic gases and NOₓ from flue gases in two steps. First, the flue gas is contacted with a scrubbing medium to absorb acidic gases to produce an intermediate flue gas. Then the intermediate flue gas is then cooled to cause nitric oxide present therein to be oxidized to form nitrogen dioxide, which is then absorbed from the flue gases to produce a nitrogen dioxide-containing solution and a scrubbed flue gas. The nitrogen dioxide in the nitrogen dioxide-containing solution is then reacted with ammonium hydroxide to form ammonium nitrate as a valuable byproduct. However, cooling the flue gas requires expensive corrosion resistant material and a lot of energy.

Yet another conventional approach for removing SO₂ from gas streams, collectively referred to as spray drying chemical absorption processes and also known as dry scrubbing, involves spraying an aqueous alkaline solution or slurry, which has been finely atomized via mechanical, dual-fluid or rotary type atomizers, into the hot gases to remove sulfur oxides and other contaminants. Major disadvantages associated with these dry scrubbing processes include moderate to high gas-side pressure drop across the spray dryer gas inlet distribution device and limitations on the spray down temperature (i.e., the approach to gas saturation temperature) required to maintain controlled operations.

There are several conventional methods for controlling emissions of nitrogen oxides (NOₓ), which include nitric oxide (NO), nitrogen dioxide (NO₂), and dimers as principle components. Selective catalytic reduction (SCR) is the most common conventional approach. In this process, ammonia is injected and mixed with the gas at medium (˜500-800° F.) temperatures. The mixture then flows across a catalyst, often vanadium based over a stainless steel substrate, and the NOₓ is reduced to elemental nitrogen (N₂). Deficiencies of conventional SCR systems include the high initial cost, the high cost of ammonia which is thermally or chemically decomposed, and the introduction of ammonia into the gas stream causing problems with the formation of ammonium bisulfate and ammonia slip to the atmosphere.

Selective non-catalytic reduction (SNCR) methods are also employed for controlling NOₓ emissions. In these processes, ammonia or urea or another ammonia based compound is injected into hot gases (˜1300-1600° F.) resulting in a direct reaction forming N₂. The problems with SNCR systems are the challenges with mixing and maintaining proper residence time and operating conditions for the reactions to take place optimally, sensitivity to changes in operating load, the high cost of the ammonia based compound which is thermally or chemically decomposed (even more than SCR's), and the introduction of ammonia into the gas stream causing problems with the formation of ammonium bisulfate and ammonia slip (as high as 50 ppm or higher) to the atmosphere. Dry injection of sodium bicarbonate (NaHCO₃) may also remove NOₓ.

Wet chemical NOₓ reduction may use oxidants, such as hydrogen peroxide (H₂O₂). Hydrogen peroxide is an oxidizing agent for organic and inorganic chemical processing as well as semiconductor applications, bleach for textiles and pulp, and a treatment for municipal and industrial waste. Hydrogen peroxide is an effective chemical reactant for scrubbing nitrogen oxides and has been used for many years. The combined use of H₂O₂ and nitric acid (HNO₃) to scrub both NO and NO₂ is an attractive option because the combination handles widely varying rates of NO to NO₂, adds no contaminants to the scrubbing solution or blow-down/waste stream, and allows a commercial product to be recovered from the process, such as nitric acid or ammonium nitrate.

Gas scrubbing is another common form of NOₓ treatment, with sodium hydroxide being the conventional scrubbing medium. However, the absorbed NOₓ is converted to nitrite and nitrate salts that may present wastewater disposal problems. Scrubbing solutions containing hydrogen peroxide are also effective at removing NOₓ, and can afford benefits not available with sodium hydroxide (NaOH). For example, H₂O₂ adds no contaminants to the scrubbing solution and so allows commercial products, such as nitric acid, to be recovered from the process. In its simplest application, H₂O₂ and nitric acid are used to scrub both NO and NO₂ from many utility and industrial sources. In addition to the methods cited above in which NOₓ is oxidized to nitric acid or nitrate salts, other conventional approaches reduce NOₓ to nitrogen using hydrogen peroxide and ammonia.

Several other processes use hydrogen peroxide to remove NOₓ. The Kanto Denka process employs a scrubbing solution containing 0.2% hydrogen peroxide and 10% nitric acid while the Nikon process uses a 10% sodium hydroxide solution containing 3.5% hydrogen peroxide. Yet another process, the Ozawa process, scrubs NOₓ by spraying a hydrogen peroxide solution into the exhaust gas stream. The liquid is then separated from the gas stream and the nitric acid formed is neutralized with ammonium hydroxide. Excess ammonium nitrate is crystallized out and the solution reused after recharging with hydrogen.

H₂O₂ is used for the measurement of NO in the Standard Reference Method 7 of the Code of Federal Regulations (CFR) promulgated test methods published in the Federal Register as final rules by the United States Environmental Protection Agency (EPA). In this procedure, an H₂O₂ solution is used in a flask to effectively capture the NOₓ.

There are at least two primary reasons that H₂O₂ has not gained widespread use as a reagent for removal of NOₓ in utility and large industrial applications. One reason is that H₂O₂ is not a selective oxidant. Most of these sources also contain other species, primarily SO₂, which are also effectively removed with hydrogen peroxide. Thus, a large quantity of H₂O₂ would be required compared to the amount of NOₓ removal sought. Even after a limestone scrubber, the amount of SO₂ present in gas may be equal to or greater than the amount of NOₓ. Another reason that H₂O₂ has not gained widespread use is the cost, especially when much more H₂O₂ is required due to reactions with SO₂, for example, which may be better done prior to the H₂O₂ stage.

The overall reactions are:
3H₂O₂+2NO→2HNO₃+2H₂O 1)
H₂O₂+2NO₂→2HNO₃ 2)
H₂O₂+SO₂→H₂SO₄ 3)

Chlorine oxide (ClO₂) supplied at a rate of approximately 1.2 kg ClO₂/kg NO is effective for rapidly converting over 90% of gas phase NO in the gas stream to NO₂. This, of course, requires proper mixing conditions. ClO₂ is a significantly stronger oxidizer than hydrogen peroxide, sodium chlorate, or sodium chlorite. Ozone is also a possible oxidizer, but has greater capital costs relative to ClO₂ generators.

Sulfur dioxide reacts with chlorine dioxide in the gas phase to form sulfuric and hydrochloric acid.
2ClO₂+5SO₂+6H₂O→5H₂SO₄+2HCl 4)

Assuming SO₂ is the dominant species in the ClO₂ reaction in the presence of SO₂ and NO, excessive amounts of ClO₂ will be required to compensate for consumption by SO₂. This will reduce the economic feasibility of using ClO₂ for removing NOx.

None of these conventional approaches for scrubbing gas streams, like gas streams, simultaneously removes mercury, mercury compounds, and NOₓ, especially elemental mercury (Hg⁰) removal. Mercury is volatilized and converted to Hg⁰ in the high temperature regions of fossil fuel combustion devices. As the gas cools, Hg⁰ is oxidized to Hg⁺². In coal-fired combustors, Hg⁰ may be oxidized to vapor phase mercuric oxide (HgO), mercuric sulfate (HgSO₄), mercuric chloride (HgCl₂), or some other vapor phase mercury compound.

Mercury may be captured, to a limited extent, using powdered activated carbon (PAC) sorbent. The activated carbon sorbent is injected into the gas stream, binds with the mercury in the gas, and captured downstream by a particulate matter control device. However, the mercury concentration in the gas stream may exceed the absorption ability of activated carbon sorbents. In addition, the performance of activated carbon sorbents may be adversely affected by low levels of chlorine in the gas. Carbon injection equipment and PAC are also relatively expensive. Also, PAC sorbent can be difficult to handle, distribute and collect in the process.

Oxidized mercury (Hg⁺² such as in the form of HgCl₂), which are water-soluble, may be effectively captured in wet scrubbers used for SO₂ control that use an alkali reagent. However, this process also requires supplemental additives, such as sodium hydrogen sulfide (NaHS), sodium tetrasulfide (Na₂S₄), or other sulfides, to chemically bind with the mercury and form compounds like mercury sulfide (HgS). However, Hg⁰ is relatively insoluble in water and must be adsorbed onto a sorbent or converted to a soluble form of mercury that can be collected by wet scrubbing.

For these and other reasons, it is desirable to provide methods for removing nitrogen oxides, sulfur dioxide and other acid gases, and mercury-containing substances, such as mercury and mercury compounds, from gas streams that overcome the various problems associated with conventional methods for scrubbing gas streams.

### SUMMARY OF THE INVENTION

The present invention provides a method of scrubbing a gas stream containing at least one acid gas substance and a mercury-containing substance comprises contacting the gas stream with an ammonium-based sorbent effective for removing at least a portion of the acid gas substance. The method further comprises contacting the gas stream with an oxidant effective to remove at least a portion of the mercury-containing substance after removing at least the portion of the acid gas substance.

In another embodiment, the present invention provides a method of scrubbing a gas stream containing at least one acid gas substance and nitrogen oxides comprising contacting the gas stream with an ammonium-based sorbent effective for removing at least a portion of the acid gas substance. The method further comprises contacting the gas stream with an oxidant effective to remove at least a portion of the nitrogen oxides after removing at least the portion of the acid gas substance.

In yet another embodiment, the present invention provides a method of scrubbing a gas stream containing at least one acid gas substance and both a mercury-containing substance and nitrogen oxides comprising contacting the gas stream with an ammonium-based sorbent effective for removing at least a portion of the acid gas substance. The method further comprises contacting the gas stream with an oxidant effective to remove at least a portion of the mercury-containing substance and the nitrogen oxides after removing at least the portion of the acid gas substance.

One benefit of the present invention is that acid gas substance is removed from the gas stream using a lower cost sorbent. The use of an ammonium alkali with oxidation produces an ammonium sulfate final product from gas phase reactions with SO₂. The ammonium alkali may be brought to the site in the form of ammonia, ammonium hydroxide, ammonium carbonate, ammonium bicarbonate, urea, and other ammonia or ammonium based alkalis or made on site at the location employing the invention using known methods such as the Haber synthesis in which ammonia is produced from hydrogen (often produced from natural gas) combined with nitrogen in the presence of heat, pressure and a catalyst (such as a porous iron catalyst prepared by reducing magnetite, Fe₃O₄).

Conveniently, activated carbon injection equipment or fixed bed activated carbon equipment to capture mercury containing substances is not required because Hg and other air toxics are removed by the staged process steps of the invention. Also, an expensive SCR, SNCR (selective non-catalytic reaction, i.e. ammonia, urea, etc. injection) or electro-catalytic oxidation systems are not required for NOₓ removal.

Further advantages include, but are not limited to, the ability to custom design each stage to meet the pollutant removal characteristics of the constituents removed in each individual stage and the ability to independently control and monitor the chemistry of each add-on stage to optimize the performance. Each stage is isolated to prevent contamination of reagents/solutions and the solutions in each add-on stage are handled separately.

The final stage can take of the present invention can be selected from one or more of the following embodiments: 1) a final wash stage using a mild acid solution to capture any ammonia that may evolve from the reactions with the ammonium alkali and acid gases (this is not be required if an acidic oxidation solution is used in the oxidant stage); 2) a wet electrostatic precipitator (wet ESP) would be used to remove, if necessary, undesirable compounds such as sulfuric acid mist, ammonium bisulfate, and other aerosols whether ammonia based or another substance, particulate matter, fine particulate matter (sometimes referred as PM 2.5), and condensable species that are not otherwise removed in upstream equipment; 3) a wet ESP field to remove most of the ammonia-based and sulfur-based aerosols followed by the oxidant stage then a second and possibly a third (if required) wet ESP field; 4) any combination of final wash and wet ESP integrated with the ammonium based acid gas removal system and oxidant system.

The present invention is particularly used for removing pollutants, such as sulfur dioxide and other acid gases such as HCl, HF, SO₂, SO₃, and H₂S, nitrogen oxides, mercury compounds, and mercury (Hg), from gas streams using ammonium alkalis for sulfur dioxide and acid gas removal, staged gas/liquid contact for removal of mercury-containing substances, CO, and nitrogen oxides. The gas streams may be generated by the combustion of fossil fuels. Ammonia based fertilizers may be produced from the removed pollutants.

These and other advantages of the present invention shall become more apparent from the accompanying drawings and description thereof.

### BRIEF DESCRIPTION OF THE DRAWING

The accompanying drawing, which is incorporated in and constitutes a part of this specification, illustrates embodiments of the invention and, together with a general description of the invention given above, and the detailed description given below, serves to explain the principles of the invention.

The Figure is a schematic representation of a scrubber arrangement in accordance with the principles of the present invention.

### DETAILED DESCRIPTION

With reference to the Figure, a scrubber arrangement 10 constitutes a two or three stage scrubber arrangement. The principles of the invention apply to all scrubbing systems for gases that contain sulfur dioxide (SO₂) and other acid gases such as HCl, HF, SO₂, SO₃, and H₂S, carbon monoxide (CO), nitrogen oxides (NOₓ), and mercury (Hg) or mercury-containing substances. The principles of the invention also apply to new installations or modifications of existing units. Scrubber arrangement 10 is used to remove acid gases including SO₂, NOₓ, and Hg from a gas stream using a staged approach. Gases 14 such as from fossil fired power plants or other such sources are first cleaned of much of the particulate matter by a primary particulate collection device such as a dry ESP, venturi, or baghouse (also called a fabric filter or bag filterhouse). In this preferred embodiment, the acid gases including sulfur dioxide are effectively removed at levels exceeding 99% by sulfur dioxide removal stage 20 from partially cleaned gas stream 18 producing a gas stream 22 which is essentially acid gas free but still contains some NOₓ and/or Hg compounds.

Due to the nature of ammonium scrubbing, a wet electrostatic precipitator (WESP) is often used to remove ammonium aerosols. In the preferred embodiment, the gas stream 22, which contains some ammonium aerosols (ammonium bisulfate, ammonium nitrate, etc.), is directed to at least one stage of a WESP 21. Here, the aerosols are removed and collected for use in making the fertilizer product prior to the oxidant stage. By removing the ammonium aerosols, the oxidant is not contaminated with ammonium that could otherwise interfere with the effectiveness of the oxidant step. The ammonium free gas stream 27 proceeds to oxidant stage 24, where CO, NOₓ and/or Hg are effectively captured producing a clean gas stream 26. For gases such as flue gases produced from the combustion of fossil fuels such as coal, coke, oil, and the like, this clean gas stream 26 would consist primarily of nitrogen, oxygen, water vapor, carbon dioxide, and other trace inert gases found in air such as argon, but is essentially devoid of pollutant gases. In some embodiments, the gas stream 26 leaving the oxidant stage 24 may contain some byproducts, such as ammonia gas, ammonium bisulfate, sulfuric acid mist, fine particulate matter, and other aerosol or condensable species, that can be washed with water and/or an appropriate solution such as an acid solution. This is accomplished using a final wash or wet ESP 28 or a combination of final wash 28 and wet ESP 28 integrated with the ammonium-based acid gas removal system and oxidant system to produce a very clean gas stream 30.

In another embodiment, the scrubber arrangement 10 is coupled with a wet scrubbing system 17 that receives a stream of gas 14 produced by a device combusting a fossil fuel or a gas from a chemical process that has a portion of the solid particulate removed. The wet scrubbing system 17 scrubs the gas stream 14 by using a conventional technology for accomplishing partial (i.e., <100%) removal of the acid gases, including SO₂ in the gas stream 14. To that end, the wet scrubbing system 17 contacts the gas in stream 14 with a scrubbing fluid that is typically composed of water and a basic chemical including, but not limited to, lime, calcium carbonate or limestone, soda ash or other sodium based alkalis, magnesium based alkalis, buffered calcium, and other calcium based alkalis, or mixtures of these materials. The scrubbing fluid may also include any of a number of additives intended to enhance removal, control chemistry, and reduce chemical scale. The wet scrubbing system removes a large fraction of the SO₂ present in the gas stream 14, perhaps 90 to 98%, or even higher, using scrubbing fluids including sodium-based, magnesium-based, or calcium-based alkalis, but does not effectively remove NOₓ, especially NO, or Hg containing substances, especially elemental Hg.

An injection scrubber 16 may optionally pre-condition the gas in stream 14 before the gas stream 14 is introduced into the wet scrubber 17. The injection scrubber 16 injects absorbents, reagents, adsorbents, or sorbents to reduce a portion of the SO₃ in the gas stream 14. A portion of the SO₂, HCl, NO₂, or other acid gases such as HF and H₂S, may also be removed by the operation of the injection scrubber 16. The injection scrubber 16 may use either wet or dry injection with any of multiple different alkali substances at any of several possible and known locations or temperature zones from the source of the gas stream 14 to the inlet of the wet scrubber 17. The injection is preferably a dry sodium bicarbonate (NaHCO₃) injection because NaHCO₃ also efficiently reacts with sulfur trioxide (SO₃), NOₓ, SO₂, and other acid gases, present in the gas stream 14. When injection of sorbents is employed in the injection scrubber 16, the need for a conventional wet electrostatic precipitator is eliminated because sulfuric acid mist is not formed when the SO₃ is effectively removed by injection scrubber upstream of the wet scrubbing system 17.

Following the optional injection step using the injection scrubber 16, wet scrubbing system 17 and/or sulfur dioxide removal system 20, as described above, is used to remove SO₂ and acidic NOₓ compounds, such as NO₂, N₂O₃ and N₂O₅ and their associated dimers (e.g., N₂O₄). In prior art, conversion of NO to NO₂ by sodium bicarbonate injection was considered undesirable because the NO₂ was a brown gas that was not captured by the downstream equipment. In this case, however, the wet scrubbing system 17 and/or sulfur dioxide removal system 20 can effectively capture some of the NO₂, N₂O₅, etc. when a sodium-based alkali is used. Some of the NO is captured directly by the sodium bicarbonate. However, NO is not effectively captured with sorbents such as lime, limestone or other calcium-based alkalis, magnesium-based alkalis, or sodium-based alkalis.

In accordance with the principles of the present invention and with continued reference to the Figure, the scrubber arrangement 10 includes an acid gas removal stage 20 that removes acid gases in a gas stream 18 supplied from the wet scrubbing system 17. Preferably, the acid gas removal stage 20 is an ammonium scrubber that effectively removes all, or substantially all, of the acid gases in gas stream 18. Alternatively, the acid gas removal stage 20 is an ammonium scrubber polishing step that effectively removes all, or substantially all, of the the acid gases in gas stream 18 remaining after treatment in the wet scrubbing system 17. The acid gas removal stage 20 will include appropriate mass transfer devices, including but not limited to any conventional combination of sprays, packing, bubble cap trays, etc., or is housed in a separate vessel, to isolate the acid gas reagent stream from the lower stage acid gas absorber stage supplied by the wet scrubbing system 17.

The acid gas removal stage 20 relies on an ammonium-based sorbent for removing at least a portion of an acid gas substance, such as SO₂. In one embodiment of the present invention, the acid gas removal stage 20 is a reaction zone that uses an ammonium alkali, preferably ammonium hydroxide (NH₄OH), as a reagent or reactant. If NH₄OH is used as the reactant, ammonium sulfate ((NH₄)₂SO₄) is produced by the following overall oxidation reaction for removal of SO₂:
2NH₄OH+SO₂+½O₂→(NH₄)₂SO₄+H₂O 5)
Similar reactions would occur for other acid gas species, including HCl, HF, SO₂, SO₃, and H₂S.

The NH₄OH used in the acid gas removal stage 20 may be purchased or, alternatively, may be produced from anhydrous ammonia or from methane on site using conventional methods such as catalytic methods as understood by persons of ordinary skill in the art. This constitutes one advantage over the use of sodium-based sorbents for acid gas removal. Alternatively, the ammonium alkali may be brought to the site of the scrubber arrangement 10 in the form of ammonia, ammonium hydroxide, ammonium carbonate, ammonium bicarbonate, urea, and other ammonia or ammonium based alkalis or made on site at the location of the scrubber arrangement 10 employing the invention using known methods such as the Haber synthesis in which ammonia is produced from hydrogen (often produced from natural gas) combined with nitrogen in the presence of heat, pressure and a catalyst (such as a porous iron catalyst prepared by reducing magnetite, Fe₃O₄).

Preferably, a significant portion or, most preferably, substantially all acid gas in the gas stream 14 is removed by the ammonium-based sorbent employed by acid gas removal stage 20 before the gas stream enters oxidant stage 24. If SO₃ is not present in gas stream 14 or if a wet ESP will be installed to control ammonium aerosols, the injection scrubber 16 may be eliminated.

The oxidant stage 24 removes at least a portion of the NOₓ, primarily in the form of NO, NO₂, or other dimers, and mercury, either in an elemental form or oxidized form from a gas stream 22 supplied from the upstream acid gas removal stage 20 and discharges a gas stream 26 that is highly depleted of these substances. Preferably, the oxidant stage 24 removes a significant portion or, most preferably, substantially all of the Hg and NOₓ from gas stream 22. The oxidant stage 24 may use a tray, like a bubble cap tray, or a separate vessel to hold the reagent, in this case an oxidant stream, separate from the lower stages so as to not interfere with the operation of the injection scrubber 16, the wet scrubber 17, and the acid gas removal stage 20. Mass transfer surfaces such as additional trays, sprays or packing may be added to the oxidant stage 24, as required. In one embodiment, the oxidant stage 24 is an integral reaction zone that recirculates an aqueous solution of oxidant and reaction products to effectively and simultaneously remove all of the NOₓ and a significant fraction of the mercury.

The gas steam 26 exiting oxidant stage 24 is free or substantially free of acid gases, which are effectively removed upstream of the oxidant stage 24 by the wet scrubber 17, the injection scrubber 16, and the acid gas removal stage 20. Moreover, the gas steam 26 is depleted of up to 90% to 99% or more of the initial mercury and NOₓ in the gas stream 14. Hence, the scrubber arrangement 10 is capable of eliminating a significant portion, if not substantially all, of the Hg, SOₓ and other acid gases, CO, and NOₓ contamination from gas stream 14.

The oxidant stage 24 is selected contingent upon the desired level of removal of NOₓ and/or Hg containing-substances. Candidate oxidants that function as a sorbent useful for capture of NOₓ and/or Hg or Hg compounds include, but are not limited to, the following substances:
1) Hydrogen Peroxide
2) Activated Hydrogen Peroxide
3) Hydrogen Peroxide/Nitric Acid Solution (H₂O₂/HNO₃)
4) Hydrogen Peroxide/Nitric Acid/Hydrochloric Acid Solution (H₂O₂/HNO₃/HCl)
5) Sodium Chlorate Solution (NaClO₃)
6) Sodium Chlorite Solution (NaClO₂)
7) Sodium Hypochlorite Solution (NaClO)
8) Sodium Perchlorite Solution (NaClO₄)
9) Chloric Acid Solution (HClO₃)
10) Oxone Solution (2KHSO₅—KHSO₄—K₂SO₄ Triple Salt)
11) Potassium Chlorate Solution (KClO₃)
12) Potassium Chlorite Solution (KClO2)
13) Potassium Hypochlorite Solution (KClO)
14) Potassium Perchlorite Solution (KClO₄)
15) Potassium Permanganate (KMnO₄)
16) Potassium Permanganate/Sodium Hydroxide Solution

Other oxidants, or combinations of oxidants, may be used in the oxidant stage 24. Further, sodium carbonate and sodium bicarbonate, or other alkalis, may be substituted for the sodium hydroxide solutions used for pH adjustment and to provide the ions for complete reactions. Oxidants may be selected to remove only NOₓ, to exclusively remove elemental Hg and mercury compounds, or to simultaneously remove NOₓ, elemental Hg, and mercury compounds. Metal ions that promote oxidation, including but not limited to iron, cobalt, and manganese, may be added to the oxidant used in the oxidant stage 24.

With regard to the use of sodium hypochlorite (NaClO) in the oxidant stage 24, potential chemical reactions between NaOCl and NOₓ and Hg include:
2NO+3NaClO+2NaOH→2NaNO₃+3NaCl+H₂O 6)
2NO+3NaClO+Na₂CO₃→2NaNO₃+3NaCl+CO₂↑ 7)
2NO+3NaClO+2NaHCO₃→2NaNO₃+3NaCl+2CO₂↑+H₂O 8)
2NO₂+NaClO+2NaOH→2NaNO₃+NaCl+H₂O 9)
2NO₂+NaClO+Na₂CO₃→2NaNO₃+NaCl+CO₂↑ 10)
2NO₂+NaClO+2NaHCO₃→2NaNO₃+NaCl+2CO₂↑+H₂O 11)
2Hg+4NaClO+2H₂O→2HgCl₂+4NaOH+O₂ 12)
In these chemical reactions, an additional source of sodium, such as bicarbonate, carbonate or hydroxide, may be provided to balance the reaction and to limit the potentially deleterious reaction of liberating Cl₂, ClO₂, or other undesirable gases. The addition of an acid source would eliminate the need for a final wash stage 28.

One reaction product of the NOₓ reactions may be converted to ammonium nitrate, a high value fertilizer product, by reaction with ammonia and carbon dioxide or ammonium bicarbonate, as indicated diagrammatically by reference numeral 23 in the Figure. The value of the fertilizer product may produce a revenue stream that offsets a portion of the cost of the equipment and consumables used in the scrubber arrangement 10. This conversion reaction will also produce sodium bicarbonate. The mercury, in the form of mercury chloride, may be separated from the oxidant solution using mercury specific ion exchange resins, as diagrammatically shown in the Figure with reference numeral 25, or using activated carbon in the liquid stream, and the nitrogenous product converted to fertilizer in block 23. Of course, mercury separation in block 25 is optional if the gas stream 22 treated by oxidant stage 24 does not contain mercury-containing substances or if the oxidant used in oxidant stage 24 does not remove mercury-containing substances from gas stream 22.

Gaseous oxidants such as ozone (O₃) or chlorine dioxide (ClO₂) may be injected into or produced by reaction in the gas stream 22 supplied to the oxidant stage 24 with, preferably, all or substantially all of the SO₂ originally in gas stream 14 removed upstream of oxidant stage 24. With proper mixing and sufficient residence, such gaseous oxidants are capable of oxidizing NO or Hg in the gas phase. Such gaseous oxidants may be capable of oxidizing NO not only to NO₂ but also to N₂O₅, which rapidly reacts with water or alkaline solutions to form nitric acid or nitrates.

The scrubber arrangement 10 may further include the optional final stage 28 to treat gas stream 26. The final stage 28, if present, washes the gas in gas stream 26 to ensure that any byproducts from the oxidant stage 24, like chlorine gas, NO₂, etc., and/or ammonia are removed. To that end, the final stage 28, if required, washes the gas stream 26 by contacting the gas stream 26 with water or an appropriate solution effective to remove these byproducts, if present. Alternately, the final stage 28 is a wet ESP with one or more stages. Additionally, one or more stages of wet ESP may be used upstream of the oxidant stage 24 prior to the final stage 28.

A gas stream 30 ultimately discharged from the scrubber arrangement 10 is advantageously depleted of, preferably, all or substantially all SOₓ, NOₓ, CO, Hg, and Hg compounds. This represents a principle benefit of the scrubber arrangement 10 of the present invention.

Further details and embodiments of the invention will be described in the following example.

### EXAMPLE

Bench-scale screening of potential solutions for capturing NOₓ and elemental mercury (Hg^{o}) was performed using a simple gaseous mixture (Hg^{o}+NO+NO₂+CO₂+H₂O+N₂+O₂) and an impinger sampling train similar to that described in the American Society of Testing and Materials Method D6784-02 (Ontario Hydro method). Testing identified solutions that effectively removed both NOₓ and Hg^{o}. The results are shown in the following table:

TABLE 1
BENCH SCALE TEST RESULTS

| | NOₓ | |
|---|---|---|
| | Removal | Hg |
| | or NO | Removal |
| | Conversion | (Hg Total |
| Solution | to NO₂ | and Hg^{o}) |
| Hydrogen Peroxide | Low | Low |
| Nitric Acid (40%) + Hydrogen Peroxide | 30-40% | 30-40% |
| Acidified Potassium Permanganate | 30-40% | ˜100% |
| Chloric Acid | Low | 30-40% |
| 0.1 M NaClO pH adjusted to 3.74 using | ˜100% | ˜100% |
| 0.25 mole/L KMnO₄ + 2.5 mole/L NaOH | ˜98% (about 4 | ˜100% |
| (pH of 11.3) | ppm | |
| | passed through) | |
| 0.1 M NaClO, pH adjusted to 6 using HCl | 75-95% | ˜100% |
| NaClO pH adjusted to 5 using HCl | ˜70% | ˜100% |

The results in Table 1 indicate that there are several possible candidate solutions from which to choose. Even the situations that show medium removal ranges such as (nitric acid (40%)+hydrogen peroxide) or acidified potassium permanganate will remove at higher rates with an appropriate modification to the mass transfer device. The oxidant selected, will then be based on economics, availability, desired level of capture, and/or desired end product. The results in Table 1 also indicate the relative ineffectiveness of H₂O₂ alone for NOₓ removal and Hg removal.

While the present invention has been illustrated by a description of various preferred embodiments and while these embodiments have been described in considerable detail in order to describe the best mode of practicing the invention, it is not the intention of applicants to restrict or in any way limit the scope of the appended claims to such detail. Additional advantages and modifications within the spirit and scope of the invention will readily appear to those skilled in the art.

The invention itself should only be defined by the appended claims, wherein we claim:

1. A method of scrubbing a gas stream containing at least one acid gas substance and a mercury-containing substance, comprising:
contacting the gas stream in a wet scrubbing system with an ammonium-based first sorbent effective for removing at least a portion of the acid gas substance; and
contacting the gas stream with an oxidant effective to remove at least a portion of the mercury-containing substance after the acid gas substance portion is removed.

2. The method of claim 1 wherein the gas stream further includes at least one of CO or nitrogen oxides, and contacting the gas stream with the oxidant further comprises:
removing at least a portion of the CO or the nitrogen oxides.

3. The method of claim 2 further comprising:
converting the nitrogen oxides into a nitrogenous reaction product; and
converting the nitrogenous reaction product to ammonium nitrate.

4. The method of claim 1 wherein the acid gas substance includes sulfur dioxide and the ammonium-based first sorbent produces a reaction product from the sulfur dioxide, and further comprising:
oxidizing the reaction product; and
processing the oxidized reaction product to produce a product containing ammonium sulfate.

5. The method of claim 1 wherein the oxidant is a an aqueous solution of a compound selected from the group consisting of hydrogen peroxide, sodium chlorate, sodium chlorite, sodium hypochlorite, sodium perchlorite, chloric acid/sodium chlorate, chloric acid, potassium chlorate, potassium chlorite, potassium hypochlorite, potassium perchlorite, potassium permanganate, ozone, chlorine dioxide, and combinations thereof.

6. The method of claim 5 wherein the solution further includes an acid selected from the group consisting of nitric acid, hydrochloric acid, sulfuric acid, and combinations thereof, or the solution further includes an alkali selected from the group consisting of caustic soda, sodium carbonate, sodium bicarbonate, and combinations thereof.

7. The method of claim 5 wherein the solution further includes metal ions.

8. The method of claim 1 wherein the gas stream is contacted with a second sorbent from an injection system or a scrubbing system that partially removes the acid gas substance before contacting the gas stream with the ammonium-based first sorbent, and the ammonium-based first sorbent removes substantially all of the acid gas substance remaining after contact with the injection system or the scrubbing system.

9. The method of claim 1 further comprising:
contacting the gas stream with a final wash and/or one or more wet electrostatic precipitator stages effective to remove byproducts from reactions between the ammonium-based first sorbent and the gas stream or byproducts from reactions between the oxidant and the gas stream.

10. The method of claim 1 further comprising:
separating the mercury-containing substance from the oxidant, after contact with the gas stream, using mercury specific ion exchange resins or activated carbon.

11. A method of scrubbing a gas stream containing at least one acid gas substance and nitrogen oxides comprising:
contacting the gas stream with an ammonium-based first sorbent effective for removing at least a portion of the acid gas substance; and
contacting the gas stream with an oxidant effective to remove at least a portion of the nitrogen oxides after the acid gas substance portion is removed.

12. The method of claim 11 further comprising:
converting the nitrogen oxides into a nitrogenous reaction product; and
converting the nitrogenous reaction product to ammonium nitrate.

13. The method of claim 11 wherein the gas stream further includes at least one of CO or a mercury-containing substance, and contacting the gas stream with the oxidant further comprises:
removing at least a portion of the CO or the mercury-containing substance.

14. The method of claim 13 further comprising:
separating the mercury-containing substance from the oxidant, after contact with the gas stream, using mercury specific ion exchange resins or activated carbon.

15. The method of claim 11 wherein the acid gas substance includes sulfur dioxide and the ammonium-based first sorbent produces a reaction product from the sulfur dioxide, and further comprising:
oxidizing the reaction product; and
processing the oxidized reaction product to produce a product containing ammonium sulfate.

16. The method of claim 11 further comprising:
converting the nitrogen oxides into a nitrogenous reaction product; and
converting the nitrogenous reaction product to ammonium nitrate.

17. The method of claim 11 wherein the oxidant is an aqueous solution of a compound selected from the group consisting of hydrogen peroxide, sodium chlorate, sodium chlorite, sodium hypochlorite, sodium perchlorite, chloric acid/sodium chlorate, chloric acid, potassium chlorate, potassium chlorite, potassium hypochlorite, potassium perchlorite, potassium permanganate, ozone, chlorine dioxide, and combinations thereof.

18. The method of claim 17 wherein the solution further includes an acid selected from the group consisting of nitric acid, hydrochloric acid, sulfuric acid, and combinations thereof, or the solution further includes an alkali selected from the group consisting of caustic soda, sodium carbonate, sodium bicarbonate, and combinations thereof.

19. The method of claim 17 wherein the solution further includes metal ions.

20. The method of claim 11 wherein the gas stream is contacted with a second sorbent from an injection system or a scrubbing system that partially removes the acid gas substance before contacting the gas stream with the ammonium-based first sorbent, and the ammonium-based first sorbent removes substantially all of the acid gas substance remaining after contact with the injection system or scrubbing system.

21. The method of claim 11 further comprising:
contacting the gas stream with a final wash and/or one or more wet electrostatic precipitator stages effective to remove byproducts from reactions between the ammonium-based first sorbent and the gas stream or byproducts from reactions between the oxidant and the gas stream.
